(19) United States
(12) Patent Application Publication
(10) Pub. No.: US 2007/0147423 A1
(43) Pub. Date: Jun. 28, 2007

(54) More Power Save Multi-Poll Indication

(76) Inventor: Menzo Wentink, Utrecht (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/613,020

(22) Filed: Dec. 19, 2006

Related U.S. Application Data
(60) Provisional application No. 60/752,291, filed on Dec. 20, 2005.

(51) Int. Cl. H04J 3/22; H04J 3/00

(52) U.S. Cl. 370/468; 370/498

(57) ABSTRACT

Various embodiments of systems and methods that provide more power save multi-poll (MPSMP) indication solutions to improve both the channel access efficiency and power saving capability. In one embodiment, for each address destination, a PSMP frame (the multi-poll frame) provides a time interval during which the client station is to receive traffic (downlink time or DLT) and the time interval during which this client station can transmit (uplink time or ULT). At any other time, such a client station may go to sleep and save power, until the next PSMP arrives. The uplink times are scheduled after the downlink times, for specific efficiency reasons. One embodiment of an MPSMP indication method enables the PSMP frame indicate whether another PSMP frame is to follow at the end of the uplink and downlink periods (or schedule) as described in the current PSMP frame, through an MPSMP indication. If the MPSMP indication is set, the client station knows to wake up immediately after the scheduled uplink and downlink times of this PSMP to receive the next PSMP.

### CROSS-REFERENCE TO RELATED APPLICATION

This application claims priority to copending U.S. provisional application entitled, “More PSMP Indication,” having Ser. No. 60/752,291, filed Dec. 19, 2005, which is entirely incorporated herein by reference.

### TECHNICAL FIELD

The present disclosure is generally related to local area networks and, more particularly, is related to systems and methods of transceiving in a wireless local area network (WLAN).

### BACKGROUND

Communication networks come in a variety of forms. Notable networks include wireline and wireless. Wireline networks include local area networks (LANs), DSL networks, and cable networks, among others. Wireless networks include cellular telephone networks, classic land mobile radio networks and satellite transmission networks, among others. These wireless networks are typically characterized as wide area networks. More recently, wireless local area networks and wireless home networks have been proposed, and standards, such as Bluetooth and IEEE 802.11, have been introduced to govern the development of wireless equipment for such localized networks.

A WLAN typically uses infrared (IR) or radio frequency (RF) communications channels to communicate between portable or mobile computer terminals and stationary access points or base stations. These access points are, in turn, connected by a wired or wireless communications channel to a network infrastructure which connects groups of access points together to form the LAN, including, optionally, one or more host computer systems.

Wireless protocols such as Bluetooth and IEEE 802.11 support the logical interconnections of such portable roaming terminals having a variety of types of communication capabilities to host computers. The logical interconnections are based upon an infrastructure in which at least some of the terminals are capable of communicating with at least two of the access points when located within a predetermined range, each terminal being normally associated, and in communication, with a single one of the access points. Based on the overall spatial layout, response time, and loading requirements of the network, different networking schemes and communication protocols have been designed so as to most efficiently regulate the communications.

IEEE Standard 802.11 (“802.11”) is set out in “Wireless LAN Medium Access Control (MAC) and Physical Layer (PHY) Specifications” and is available from the IEEE Standards Department, Piscataway, N.J. 802.11 permits either IR or RF communications at 1 Mbps, 2 Mbps and higher data rates, a medium access technique similar to carrier sense multiple access/collision avoidance (CSMA/CA), a power-save mode for battery-operated mobile stations, seamless roaming in a full cellular network, high throughput operation, diverse antenna systems designed to eliminate “dead spots,” and an easy interface to existing network infrastructures.

As communication devices become smaller, while providing increasing functionality, battery life and the ability to recover quickly from a power save mode raise significant design challenges. Thus, a heretofore unaddressed need exists in the industry to address the aforementioned deficiencies and inadequacies.

### SUMMARY

Embodiments of the present disclosure provide systems and methods for more power save multi-poll indication. Briefly described, in architecture, one embodiment of the system, among others, can be implemented as a processor configured to receive a first power save multi-poll frame (PSMP), the first PSMP frame comprising: a time interval during which an associated client station may be active in a network; and a more PSMP indication, wherein the more PSMP indication indicates whether a subsequent PSMP frame will follow at the end of the time interval.

Embodiments of the present disclosure can also be viewed as providing methods for more power save multi-poll indication. In this regard, one embodiment of such a method, among others, can be broadly summarized by the following steps: receiving a first power save multi-poll frame (PSMP); and determining from the first PSMP frame an indication of: a time interval during which an associated client station may be active in a network; and a more PSMP indication, wherein the more PSMP indication indicates whether a subsequent PSMP frame will follow at the end of the time interval.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an open system interconnection (OSI) layered model for data transmission.

FIG. 2 is a diagram of an exemplary embodiment of a communication system comprising two stations and an access point (AP) using the OSI model of FIG. 1

FIG. 3 is a block diagram of consecutive power save multi-poll (PSMP) frames of a transmission in the communication system of FIG. 2.

FIG. 4 is a flow chart of a method embodiment comprising more PSMP indication of the communication system of FIG. 2.

FIG. 5 is a diagram of a PSMP frame format for an exemplary embodiment of more PSMP indication of the communication system of FIG. 2.

FIG. 6 is a diagram of an exemplary embodiment of a station information field format for the PSMP frame format of FIG. 5.

### DETAILED DESCRIPTION

Disclosed herein are various communication system and method embodiments. Such communication systems comprise, in one exemplary embodiment, an access point and one or more client devices that enable an exchange of more power save, multi-poll indications. To preserve battery life on portable WLAN clients, the 802.11 specification provides for power save operations on client devices. Power save operations may be performed in any type of processor such as a MAC layer processor, though not limited to a MAC layer processor, including, but not limited to, a digital signal processor (DSP), a microprocessor unit (MCU), a general purpose processor, and an application specific integrated circuit (ASIC), among others. Because certain embodiments of communication systems that provide for the exchange of more PSMP indication are described herein in the context of an 802.11n system, a brief description of 802.11 and layers in a wireless LAN (WLAN) follows with the understanding that the disclosed systems and methods may similarly apply to other communications systems.

IEEE 802.11n (the “802.11n proposal”) is a high data rate extension of the 802.11a standard at 5 gigahertz (GHz) and 802.11g at 2.4 GHz. Both of these standards use orthogonal frequency division multiplexing (OFDM), which is a signaling scheme which uses multiple, parallel tones to carry the information. These tones are commonly called subcarriers. It is noted that, at the present time, the 802.11n proposal is only a proposal and is not yet a completely defined standard. Other applicable standards include Bluetooth, xDSL, other sections of 802.11, etc. To increase the data rate, 802.11n is considering using a more PSMP indication.

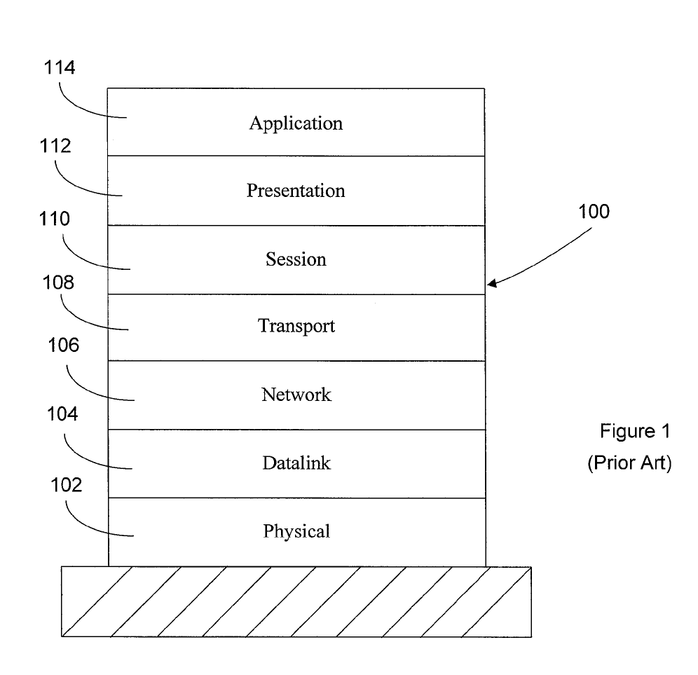

IEEE 802.11 is directed to wireless LANs, and in particular specifies the MAC and the PHY layers. These layers are intended to correspond closely to the two lowest layers of a system based on the ISO Basic Reference Model of OSI, i.e., the data link layer and the physical layer. FIG. 1 shows a diagrammatic representation of an open systems interconnection (OSI) layered model 100 developed by the International Organization for Standards (ISO) for describing the exchange of information between layers in communication networks. The OSI layered model 100 is particularly useful for separating the technological functions of each layer, and thereby facilitating the modification or update of a given layer without detrimentally impacting on the functions of neighboring layers.

At a lower most layer, the OSI model 100 has a physical layer or PHY layer 102 that is responsible for encoding and decoding data into signals that are transmitted across a particular medium. Above the PHY layer 102, a data link layer 104 is defined for providing reliable transmission of data over a network while performing appropriate interfacing with the PHY layer 102 and a network layer 106. The network layer 106 is responsible for routing data between nodes in a network, and for initiating, maintaining and terminating a communication link between users connected to the nodes. A transport layer 108 is responsible for performing data transfers within a particular level of service quality. A session layer 110 is generally concerned with controlling when users are able to transmit and receive data. A presentation layer 112 is responsible for translating, converting, compressing and decompressing data being transmitted across a medium. Finally, an application layer 114 provides users with suitable interfaces for accessing and connecting to a network.

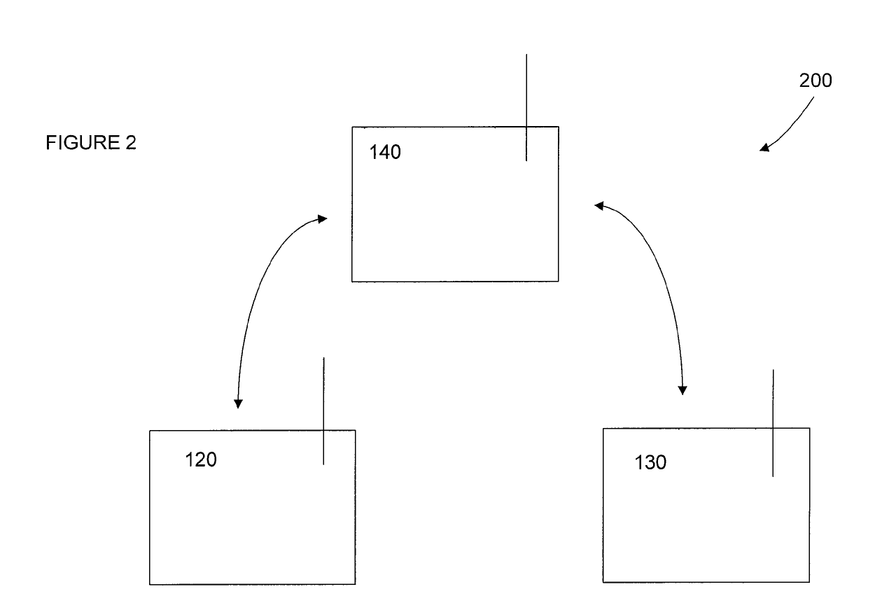

This OSI model 100 can be useful for transmissions between, for example, two client stations, 120, 130 and access point (AP) 140 as shown in FIG. 2. An embodiment of a communication system 200 is shown that provides for more PSMP indication, and, in one embodiment, is configured as a basic service set (BSS). A BSS is a group of 802.11 client stations such as client stations 120, 130 communicating with one another. AP 140 is the central point of communications for all client stations in a BSS Client stations 120, 130 and AP 140, of communication system 200 may comprise transceivers for transmitting and receiving data streams between client stations 120, 130 through AP 140, and may include multiple antennas for receiving and/or transmitting. Client stations 120, 130 and AP 140 do not necessarily have the same number of antennas. Client stations 120, 130 and AP 140 may transmit using, as non-limiting examples, a time division multiple access (TDMA) protocol or a Carrier Sense Multiple Access with Collision Avoidance (CSMA/CA) protocol, or a combination of the same and/or other protocols. Although only two client stations are provided in this example, the disclosed principles of MPSMP indication are also applicable to larger networks with more devices.

In some embodiments, each client station 120, 130 and AP 140 comprises a PHY signal processor configured to implement power save operations, in addition to performing more PSMP functionality. That is, each PHY signal processor, alone, or in combination with other logic or components, implements the functionality of the various embodiments. Functionality of power save operations and/or more PSMP may be embodied in a wireless radio, or other communication device. Such a communication device may include many wireless communication devices, including computers (desktop, portable, laptop, etc.), consumer electronic devices (e.g., multi-media players), compatible telecommunication devices, personal digital assistants (PDAs), or any other type of network devices, such as printers, fax machines, scanners, hubs, switches, routers, set-top boxes, televisions with communication capability, etc.

In one embodiment, a power save (PS) operation may involve client station 120, for example, entering low power mode by turning off the client station transceiver. AP 140 buffers frames addressed to client station 120 while client station 120 is in power save mode. At a given interval, client station 120 wakes up and listens for a beacon from AP 140 indicating whether frames are buffered for client station 120.

A multi-poll solution is a channel access mechanism in which a beacon (or poll) is sent to multiple client stations 120, 130 at once using a broadcast or multicast receiver address, instead of to each client station 120, 130 individually, (e.g., instead of sequentially). A multi-poll solution may include a time slot for each polled client station 120, 130 during which they should transmit and/or receive. In other words, multi-poll AP 140 polls multiple client stations at once. Multicast/broadcast power save operations may use an AP-defined interval, which is advertised in the beacons of AP 140. For instance, client station 120 wakes up and listens to the beacon frames to determine whether frames are buffered. If AP 140 has indeed buffered frames for client station 120, client station 120 polls AP 140 for the frames. If AP 140 has not buffered frames, client station 120 returns to low-power mode until the wake-up interval.

When client station 120 associates to AP 140, in broadcast operation, an administrator specifies a listen interval value in an association request frame. The listen interval is the number of beacons client station 120 waits before transitioning to active-mode. For example, a listen interval of 200 indicates that client station 120 wakes up from power save mode every 200 beacons. The beacon frame includes a traffic indication map (TIM) information element. The element contains a list of all association identifiers (AIDs) that have traffic buffered at AP 140. In one embodiment, there may be up to 2,008 unique AIDs, so the TIM element alone may be up to 251 bytes.

To minimize network overhead, the TIM may utilize a shorthand method of listing the AIDs. The AID of client station 140 is not explicitly stated in a protocol decoding operation. To determine the AID of client station 120, non-limiting examples of the following information may be used: a value of a link field, a value of a bit map offset field, and/or a value of a partial virtual bit map field. IEEE 802.11 specifies a traffic indication virtual bit map as a mechanism to indicate which client station AlDs have frames buffered. In one embodiment, the virtual bit map spans from AID1 to AID2007. AIDO is reserved for multicast/broadcast. Additionally, a special TIM information element known as a DTIM, indicates whether broadcast or multicast traffic is buffered at AP 140.

The partial virtual bit map eliminates all unnecessary zero flag values by summarizing them. All client stations 120, 130 that have frames buffered (and therefore have flag values of 1 in the traffic indication virtual bit map) are included in the partial virtual bit map. All AlDs with the flag value of zero leading up to the partial virtual bit map are summarized by a derived value referred to as “x”. Client station 120 may send a PS-poll frame to AP 140 to request any buffered frames on AP 140. AP 140 responds to the PS-poll frame with one of the client station's buffered frames and an indication of whether more frames are buffered.

Broadcast and multicast frames are buffered for all client stations (including non-power save client stations) in the communication system 200 when one or more power save client stations is associated to AP 140. In one embodiment, the TIM has two fields to indicate whether multicast/broadcast traffic is buffered and how long until the buffered traffic is delivered to the BSS: the DTIM count field and the DTIM period field. The DTIM count field indicates how many beacons until the delivery of the buffered frames. A value of zero indicates that the TIM is a DTIM and if there are buffered frames, they will be transmitted immediately following the beacon. The DTIM period field indicates the number of beacons between DTIMs. For example, a value of 10 indicates that every tenth beacon will contain a DTIM.

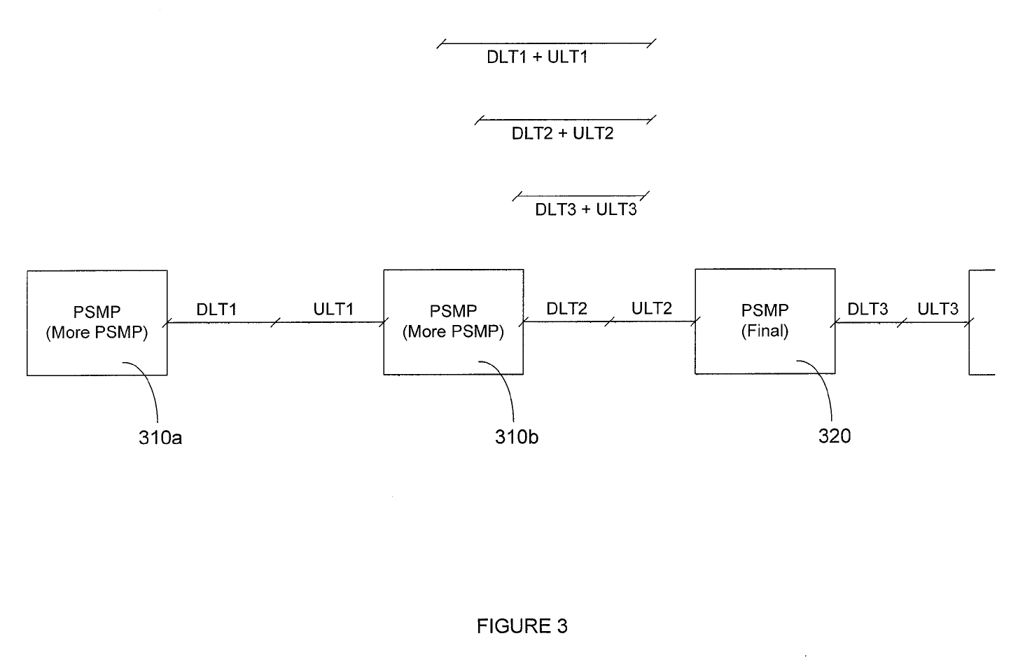

FIG. 3 provides a stream of PSMP frames separated in time by downlink and uplink periods. Referring to FIG. 3, functionality of an embodiment of the communication system 200 for providing more power save multi-poll (MPSMP) indication is illustrated in a manner designed to improve both the channel access efficiency and power saving capability. For each address destination, the PSMP frame (the multi-poll frame) provides the time interval during which client station 120 will receive traffic (downlink time or DLT) and the time interval during which client station 120 can transmit (uplink time or ULT). At any other time, client station 120 may go to sleep and save power, until the next PSMP arrives.

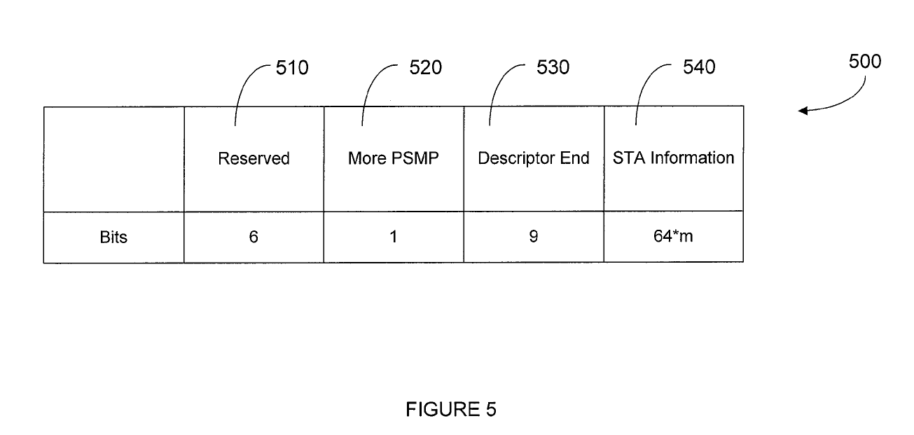

Referring to FIG. 5, exemplary embodiment PSMP frame format 500 is provided. Bits 510, 6 bits in this embodiment, may be reserved. Bit 520 is the MPSMP bit. Bits 530, 9 bits in this embodiment, are descriptor end bits. Bits 540 are station information bits.

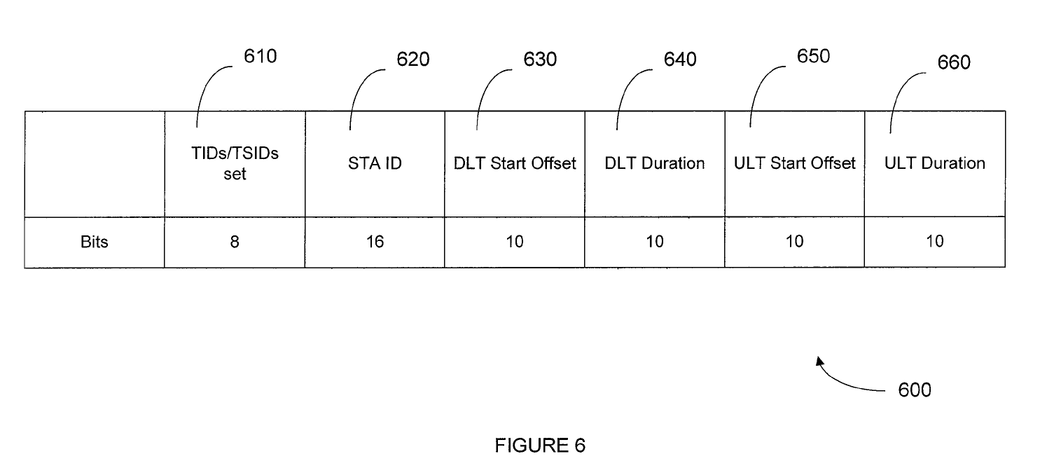

Station information bits 540 are provided in more detail in FIG. 6.

Exemplary embodiment station information format 600 includes, without limitation, eight bits for traffic identification/traffic stream identification 610;

sixteen bits for station identification 620; ten bits for downlink time start offset 630; ten bits for downlink time duration 640; ten bits for uplink time start offset 650; and ten bits for uplink time duration 660.

In some embodiments, the uplink times may be scheduled after the downlink times, for instance, for efficiency reasons. MPSMP indication methodology is described below from the perspective of a PHY signal processor in a client, with the understanding that similar functionality may be implemented in an AP. One embodiment of the MPSMP indication method allows the PSMP frame to indicate whether another PSMP frame will follow at the end of the uplink and downlink periods (or schedule) as described in the current PSMP frame, through a “more PSMP” indication 310a, 310b, as shown in FIG. 3. If MPSMP indication 310a, 310b is set, client station 120 knows to wake up immediately after the scheduled uplink and downlink times of this PSMP to receive the next PSMP.

MPSMP indication 310a, 310b may be used so that AP 140 may, during the transmit and receive phases of the current PSMP, receive new traffic, generate response traffic such as acknowledgements, or find that certain frames need to be re-transmitted, which AP 140 did not know about when generating the current PSMP schedule. MPSMP indication 310a is a simple mechanism to allow for reacting to newly generated (or received) traffic.

Generally, each PSMP period will be shorter than the previous one as shown in FIG. 3. MPSMP indications 310a, 310b indicate that another PSMP 310b, 320, respectively, will follow after the scheduled uplink (ULT) and downlink (DLT) times. When the indication is not set, as in final indication 320, the current PSMP frame is the final PSMP in the sequence and client station 120 does not need to wake up at the end of the uplink period.

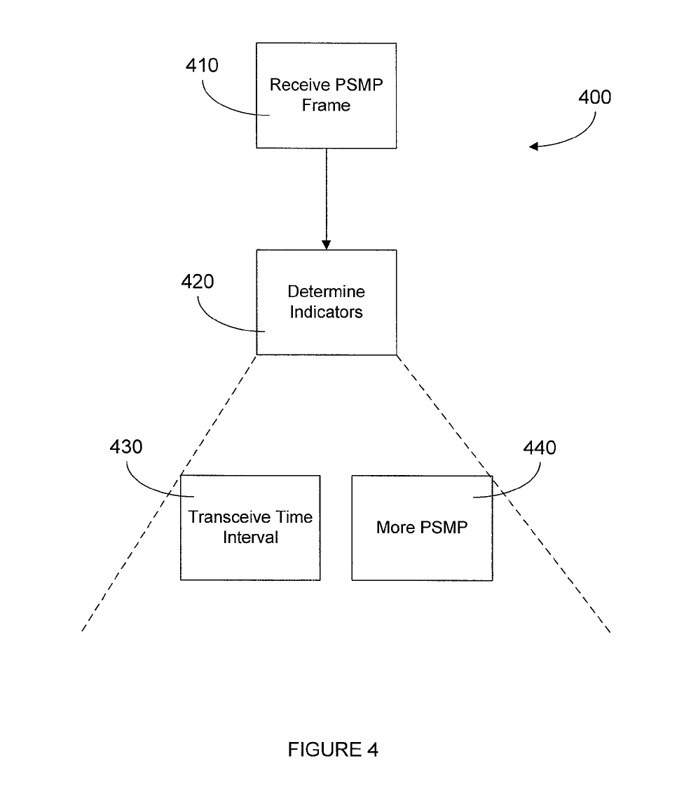

FIG. 4 is a flow chart of method of MPSMP indication 400. In block 410 a PSMP frame is received by client 120, for example. In block 420, indicators in the PSMP frame are determined. The indicators may include transmit, receive, and/or transceive time interval 430 and MPSMP indication 440.

Transmit time interval 430 may indicate a time interval during which an associated transmitter may transmit. MPSMP indication 440 may indicate whether a subsequent PSMP frame will follow at the end of transmit and receive time interval 430. In an exemplary embodiment, if the PSMP indicates active time for several stations and the more PSMP bit is set, then there is not another PSMP after each individual active time, but only after the last one.

In one exemplary embodiment of a method of MPSMP indication, the PSMP may indicate whether it is the final PSMP. In another exemplary embodiment, an assumption is made that there is a next PSMP. However, when more PSMP indication is empty, the lack of more PSMP indication implicitly indicates that the PSMP is the final PSMP. However, without a more PSMP indication, retransmissions and acknowledgements for received uplink data are postponed until the next scheduled (or unscheduled) PSMP period. When a more PSMP indication is used, retransmissions and acknowledgements can be transmitted as part of a single sequence of PSMP frames.

Embodiments of the present disclosure can be implemented in hardware, software, firmware, or a combination thereof in client station 120, 130 and AP 140. In exemplary embodiment(s), the MPSMP indication is implemented in software or firmware that is stored in a memory and that is executed by a suitable instruction execution system. If implemented in hardware, as in an alternative embodiment, the MPSMP indication can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the exemplary embodiments of the present disclosure in which functions may be executed out of order from that shown or discussed, including substantially concurrently or in reverse order, depending on the functionality involved, as would be understood by those reasonably skilled in the art of the present disclosure.

Certain method embodiments of MPSMP indication may be embodied as a program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium”can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the present disclosure includes embodying the functionality of the exemplary embodiments of the present disclosure in logic embodied in hardware or software-configured mediums.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. An apparatus comprising:
a processor configured to receive a first power save multi-poll frame (PSMP), the first PSMP frame comprising:
a time interval during which an associated client station may be active in a network; and
a more PSMP indication, wherein the more PSMP indication indicates whether a subsequent PSMP frame will follow at the end of the time interval.

2. The apparatus of claim 1, wherein if the more PSMP indication is set, the processor prepares to receive the subsequent frame at the end of the time interval.

3. The apparatus of claim 1, wherein the subsequent PSMP frame indicates that the subsequent PSMP frame is a final PSMP frame.

4. The apparatus of claim 1, wherein the apparatus is one of a radio, a computer, a multi-media player, a personal digital assistant, a printer, a fax machine, a scanner, a hub, a switch, a router, a set-top box, and a television.

5. The apparatus of claim 1, further comprising one or more of a transmitter for transmitting during the indicated transmit time interval, a receiver for receiving during the indicated receive time interval, and a transceiver for transceiving during a transceive time interval.

6. The apparatus of claim 1, wherein the time interval is one of a transmit time interval, a receive time interval, and a transmit and receive time interval.

7. The apparatus of claim 1, wherein if the first PSMP frame indicates active time for several client stations and the more PSMP bit is set, then there is not another PSMP after each individual active time, but only after a final active time.

8. A method comprising:
receiving a first power save multi-poll frame (PSMP); and
determining from the first PSMP frame an indication of:
a time interval during which an associated client station may be active in a network; and
a more PSMP indication, wherein the more PSMP indication indicates whether a subsequent PSMP frame will follow at the end of the time interval.

9. The method of claim 8, wherein if a more PSMP indication is determined from the PSMP, further comprising preparing to receive the subsequent frame at the end of the time interval.

10. The method of claim 8, further comprising determining whether the subsequent PSMP frame is a final PSMP frame.

11. The method of claim 8, wherein receiving the first PSMP comprises receiving the first PSMP in at least one of a radio, a computer, a multi-media player, a personal digital assistant, a printer, a fax machine, a scanner, a hub, a switch, a router, a set-top box, and a television.

12. The method of claim 8, further comprising one or more of transmitting during an indicated transmit time interval, receiving during an indicated receive time interval, and transceiving during an indicated transceive time interval.

13. The method of claim 8, wherein the time interval is one of a transmit time interval, a receive time interval, and a transceive time interval.

14. A computer readable medium comprising:
logic configured to receive a first power save multi-poll frame (PSMP);
and
logic configured to determine from the first PSMP frame an indication of:
a time interval during which an associated client station may be active in a network; and
a more PSMP indication, wherein the more PSMP indication indicates whether a subsequent PSMP frame will follow at the end of the time interval.

15. The computer readable medium of claim 14, wherein if a more PSMP indication is determined from the PSMP, further comprising logic configured to prepare to receive the subsequent frame at the end of the time interval.

16. The computer readable medium of claim 14, further comprising logic configured to determine whether the subsequent PSMP frame is a final PSMP frame.

17. The computer readable medium of claim 14, wherein logic configured to receive the first PSMP comprises logic configured to receive the first PSMP in at least one of a radio, a computer, a multi-media player, a personal digital assistant, a printer, a fax machine, a scanner, a hub, a switch, a router, a set-top box, and a television.

18. The computer readable medium of claim 14, further comprising one or more of logic configured to transmit during an indicated transmit time interval, logic configured to receive during an indicated receive time interval, and logic configured to transceive during an indicated transceive time interval.

19. The computer readable medium of claim 14, wherein the time interval is one of a transmit time interval, a receive time interval, and a transceive time interval.
